(19) United States
(12) Patent Application Publication
(10) Pub. No.: US 2010/0250279 A1
(43) Pub. Date: Sep. 30, 2010

(54) METHOD, APPARATUS AND COMPUTER PROGRAM PRODUCT FOR PROVIDING MANAGED CARE OF UNCOMPENSATED POPULATIONS

(76) Inventors: Ricardo Guggenheim, Miami, FL (US); Keith Norsym, Chicago, IL (US); Teresa Treiger, Holbrook, MA (US); Shreyas Shah, Park Ridge, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/415,328

(22) Filed: Mar. 31, 2009

(51) Int. Cl. G06Q 50/00; G06Q 90/00

(52) U.S. Cl. 705/3; 705/2; 705/10

(57) ABSTRACT

An apparatus for providing management of uncompensated populations may include processing circuitry. The processing circuitry may be configured to receive patient information corresponding to uncompensated patient treatment events associated with a plurality of patients, apply a screening criteria to identify a patient eligible for care management assignment in which the screening criteria includes qualifications based on uncompensated cost and an identity of a condition for which the patient received treatment, and assign the patient to a selected intervention program based at least in part on the qualifications of the patient.

### TECHNOLOGICAL FIELD

Embodiments of the present invention relate generally to health care management solutions and, more particularly, relate to a method, apparatus, and computer program product for providing managed care of uncompensated populations.

### BACKGROUND

Healthcare system improvements are continually being developed and sought after by providers and consumers alike. As health systems face economic pressures to increase their bottom line, there is also an increasing number of uninsured and underinsured patients seeking health care services. Servicing such patients can sometimes lead to uncompensated costs that end up being absorbed by healthcare systems and stressing the ability of such systems to provide quality health care service. Moreover, losses associated with uncompensated populations (e.g., uninsured or underinsured individuals) may, in some cases, interfere with the ability of healthcare systems to provide support for other types of reimbursable care due to opportunity losses, the loss of capacity and consumption of resources that may be associated with providing uncompensated care.

For individuals with no coverage, poor coverage or intermittent coverage, the hospital emergency department may often end up being the usual source of primary and non-urgent medical care. Accordingly, it may be desirable to provide an improved mechanism by which care management can be provided to uncompensated populations in a way that saves cost without necessarily sacrificing service.

### BRIEF SUMMARY

A method, apparatus and computer program product are therefore provided for providing managed care of uncompensated populations. Accordingly, for example, patient information and claims can be used to screen populations to identify candidates for participation in health care programs that may provide proactive engagement with such candidates in an effort to reduce the likelihood that such candidates will incur uncompensated health care costs associated with, for example, emergency department visits or other healthcare services. In some examples, patients with manageable chronic conditions may be classified based on characteristics associated with such patients and their corresponding claim histories.

In one exemplary embodiment, a method of providing care management of uncompensated populations is provided. The method may include receiving patient information corresponding to uncompensated patient treatment events associated with a plurality of patients, applying a screening criteria to identify a patient eligible for care management assignment in which the screening criteria includes qualifications based on uncompensated cost and an identity of a condition for which the patient received treatment, and assigning the patient to a selected intervention program based at least in part on the qualifications of the patient.

In another exemplary embodiment, a computer program product for providing care management of uncompensated populations is provided. The computer program product includes at least one computer-readable storage medium having computer-executable program code instructions stored therein. The computer-executable program code instructions may include program code instructions for receiving patient information corresponding to uncompensated patient treatment events associated with a plurality of patients, applying a screening criteria to identify a patient eligible for care management assignment in which the screening criteria includes qualifications based on uncompensated cost and an identity of a condition for which the patient received treatment, and assigning the patient to a selected intervention program(s) based at least in part on the qualifications of the patient.

In another exemplary embodiment, an apparatus for providing care management of uncompensated populations is provided. The apparatus may include processing circuitry. The processing circuitry may be configured to receive patient information corresponding to uncompensated patient treatment events associated with a plurality of patients, apply a screening criteria to identify a patient eligible for care management assignment in which the screening criteria includes qualifications based on uncompensated cost and an identity of a condition for which the patient received treatment, and assign the patient to a selected intervention program based at least in part on the qualifications of the patient.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an apparatus for providing managed care of uncompensated populations according to an exemplary embodiment of the present invention;

FIG. 2 is a flow diagram illustrating several exemplary operations associated with providing managed care of uncompensated populations according to an exemplary embodiment of the present invention; and

FIG. 3 is a block diagram according to an exemplary method for providing management of uncompensated populations according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at reducing or otherwise controlling costs associated with managing uncompensated populations (e.g., uninsured or underinsured individuals). In this regard, for example, some embodiments of the present invention may provide a way to proactively engage specific patients in a manner that may reduce the likelihood that the specific patients will cause the healthcare system to incur health care expenses, for example, in the emergency department or other in or out-patient facilities that are likely to end up being uncompensated. In some cases, a specific health care management program tailored to a selected patient's condition and behavior may be implemented to provide information, medications, a medical home and in some cases also other services to the selected patient with the goal being that the cost of the proactive engagement is less than uncompensated costs that may otherwise be likely to be incurred if the selected patient visits the emergency department or incurs other uncompensated health care costs. As such, by engaging the specific patients selected according to an exemplary embodiment of the present invention, health care systems may realize a net savings with respect to the cost of employing the proactive engagement policies described herein as compared to the cost of emergency department or other hospital visits that would otherwise be likely to occur.

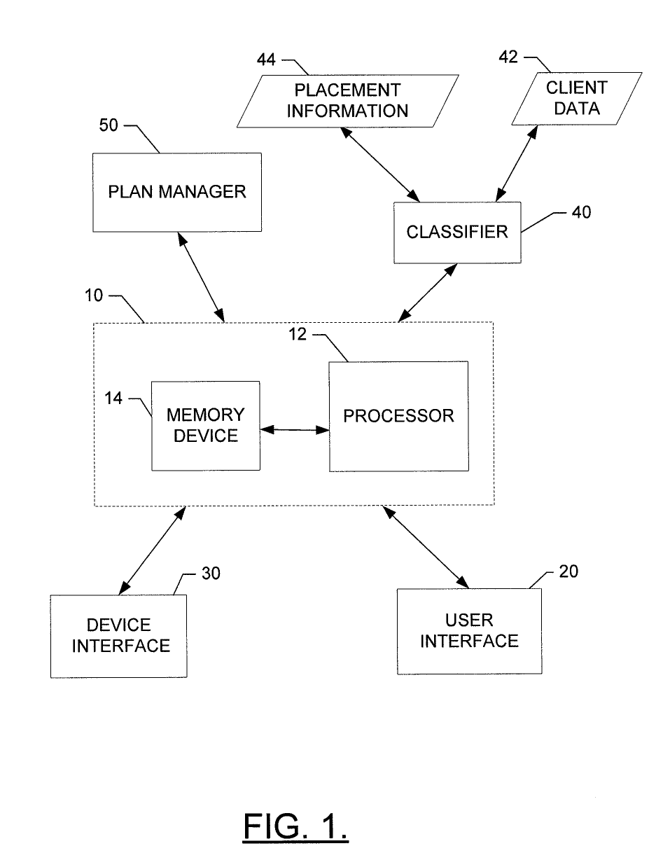

An example of an apparatus for performing exemplary embodiments of the present invention is provided in FIG. 1. In one embodiment, the apparatus may include processing circuitry 10 that is configured to perform patient classification according to an exemplary embodiment of the present invention. In one embodiment, the processing circuitry 10 may include a processor 12, a storage device 14 that may be in communication with or otherwise control a user interface 20 and a device interface 30. As such, the processing circuitry 10 may be embodied as a circuit chip (e.g., an integrated circuit chip) configured (e.g., with hardware, software or a combination of hardware and software) to perform operations described herein. However, in some embodiments, the processing circuitry 10 may be embodied as a portion of a server, computer, laptop, workstation or even one of various mobile computing devices. In situations where the processing circuitry 10 is embodied as a server or at a remotely located computing device, the user interface 20 may be disposed at another device (e.g., at a computer terminal or client device) that may be in communication with the processing circuitry 10 via the device interface 30 and/or a network.

The user interface 20 may be in communication with the processing circuitry 10 to receive an indication of a user input at the user interface 20 and/or to provide an audible, visual, mechanical or other output to the user. As such, the user interface 20 may include, for example, a keyboard, a mouse, a joystick, a display, a touch screen, a microphone, a speaker, a cell phone, or other input/output mechanisms.

The device interface 30 may include one or more interface mechanisms for enabling communication with other devices and/or networks. In some cases, the device interface 30 may be any means such as a device or circuitry embodied in either hardware, software, or a combination of hardware and software that is configured to receive and/or transmit data from/to a network and/or any other device or module in communication with the processing circuitry 10. In this regard, the device interface 30 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 30 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an exemplary embodiment, the storage device 14 may include one or more memory devices such as, for example, volatile and/or non-volatile memory that may be either fixed or removable. The storage device 14 may be configured to store information, data, applications, instructions or the like for enabling the apparatus to carry out various functions in accordance with exemplary embodiments of the present invention. For example, the storage device 14 could be configured to buffer input data for processing by the processor 12. Additionally or alternatively, the storage device 14 could be configured to store instructions for execution by the processor 12. As yet another alternative, the storage device 14 may be one of a plurality of databases that store patient information, claims information and/or program descriptions or criteria.

The processor 12 may be embodied in a number of different ways. For example, the processor 12 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 12 may be configured to execute instructions stored in the storage device 14 or otherwise accessible to the processor 12. As such, whether configured by hardware or software methods, or by a combination thereof, the processor 12 may represent an entity (e.g., physically embodied in circuitry) capable of performing operations according to embodiments of the present invention while configured accordingly. Thus, for example, when the processor 12 is embodied as an ASIC, FPGA or the like, the processor 12 may be specifically configured hardware for conducting the operations described herein. Alternatively, as another example, when the processor 12 is embodied as an executor of software instructions, the instructions may specifically configure the processor 12, which may in some cases otherwise be a general purpose processing element or other functionally configurable circuitry if not for the specific configuration provided by the instructions, to perform the operations described herein.

In an exemplary embodiment, the processor 12 (or the processing circuitry 10) may be embodied as, include or otherwise control a classifier 40 and/or a plan manager 50. The classifier 40 and the plan manager 50 may each be any means such as a device or circuitry operating in accordance with software or otherwise embodied in hardware or a combination of hardware and software (e.g., processor 12 operating under software control, the processor 12 embodied as an ASIC or FPGA specifically configured to perform the operations described herein, or a combination thereof) thereby configuring the device or circuitry to perform the corresponding functions of the classifier 40 or plan manager 50, respectively, as described below.

In an exemplary embodiment, the classifier 40 may be configured to receive information regarding patients and/or patient health care claims and screen the received information in order to classify and selectively assign some of the patients associated with the received information to be placed into programs suited to the classification of the corresponding patients. Thus, as shown in FIG. 1, the classifier 40 may be configured to receive client data 42 and produce classification results and/or placement information 44 based on the client data 42 and predefined screening and classification criteria. As such, the classifier 40 may utilize rules, thresholds, inclusions, exclusions, or other criteria for identifying patients that qualify for participation in a health care management program and further assign qualified patients to a corresponding health care management program.

In an exemplary embodiment, the plan manager 50 may implement by execution of plan initiatives or by providing instructions and/or documentation directing execution of plan initiatives, the corresponding activities associated with the plan to which each patient is assigned. As such, for example, the plan manager 50 may conduct, or direct via the provision of plan details to a human operator, implementation of plan initiatives such as contacting selected patients, providing such patients with information, assessing patient needs, providing patient resources, and/or the like. The plan manager 50 may also be configured to provide reports, summaries and/or other like information to patients, clients (e.g., healthcare systems) or other authorized parties.

In some embodiments, the plan manager 50 may be configured to manage or conduct certain aspects of the program into which the classifier 40 places a particular patient. Thus, for example, the classifier 40 may be configured to receive claims information and/or other patient information for a plurality of patients seen in a particular healthcare system. The classifier 40 may then apply exclusionary criteria to eliminate some of the patients and apply thresholds, rules or other criteria to data regarding patient treatment events (e.g., frequency of care provision, cost of such care, reason for services provided, etc.) to identify patients eligible for placement in a care management program. In this regard, the classifier 40 may be configured to apply medical and age exclusions for patient screening. The classifier 40 may also exclude patients treated for exclusionary conditions (e.g., conditions that are not considered managed conditions or chronic conditions for which preemptive or telephonic intervention may not be useful in reducing the likelihood of readmission or repeated provision of care services). The classifier 40 may also screen patients on the basis of cost. For example, since expenses incurred to prevent patients with low cost claims from having repeat service or treatment will have less chance of providing a significant savings, high cost patients (e.g., relative to a predetermined threshold of cost) may be selected for inclusion in a care management program. In some embodiments, proprietary or other risk stratification models may be used to identify impactable patients for inclusion in proactive care management programs that may save uncompensated costs from incurring in the future.

After screening and applying exclusionary criteria, eligible patients may then be further classified based on data associated with their patient history over a predefined period of time. As such, the classifier 40 may be configured to assign eligible patients (e.g., those candidate patients that have not been excluded or otherwise considered ineligible due to cost, condition, age, or other criteria) to one of a plurality of different care management programs tailored to preemptive intervention some examples of which are described below.

In some embodiments, once a patient is assigned to a particular care management program, manual program management tasks may be undertaken by nurses, telephone operators, administrators, doctors and/or other healthcare or service professionals. However, in some cases, program management tasks may be managed by the plan manager 50 or a combination of the plan manager 50 and manual actions or tasks taken by individuals such as those listed above. In embodiments involving a combination of activities, the plan manager 50 may maintain information about each patient and conduct certain tasks automatically according to plan guidelines or protocols or in combination with involvement of one or more of the individuals listed above. As such, for example, a patient enrolled in a particular care management program may be called or visited by a nurse or other health care professional to confirm the patient's suitability for the program to which the patient was assigned. An initial healthcare assessment may also be completed either telephonically or in person in order to identify barriers to care, which may impede a patient's access to consistent and reliable care. The initial assessment may also identify common medical risk issues such as smoking or obesity. Additionally, condition specific assessments may be implemented for certain conditions such as, diabetes, coronary artery disease, heart failure, chronic obstructive pulmonary disease and asthma. The information received from the initial assessment may be used by the plan manager 50 in order to generate actionable activities (e.g., in a list format) to serve as a basis for ongoing care management according to the protocols of the corresponding care management program. The list may be communicated to a medical home that may be assigned to the patient and/or to health system case managers.

In some embodiments, the classifier 40 may assign a medical home to each patient that is assigned to a care management program. However, in alternative embodiments, the assignment of a medical home may be made by the plan manager 50 after the patient has been assigned to a care management program and the initial assessment information has been considered. In any case, the medical home may be one of a predefined group of primary care providers that are either employed by the health care system or are affiliated with the health care system for the purposes of providing services defined in a particular care management program. Providers may receive new patient notifications and assessment results from the plan manager 50 via any of a number of potentially suitable mechanisms (e.g., via email, a formatted message system, or as an entry to a secure health care management website or portal). Provider offices may then collaborate with personnel associated with the plan manager 50 (e.g., case managers) in order to schedule initial patient appointments, if needed, and to remind patients (e.g., via phone, email, mail, or other methods) of initial and follow-up appointments.

In an exemplary embodiment, the plan manager 50 may be further configured to provide educational resources for patients assigned to a particular care management program. In this regard, for example, the plan manager 50 may provide information to the patient (e.g., in the form of mailed information packets, emails, or other materials) to inform the patient of resources available for education and/or advice relating to the managed condition that served as the basis for their admission to the particular care management program. In some cases, the resources may include a phone number or web address for access to an audio or video health library including a plurality of health related topics for patients to access at their convenience. The topics may be widely varied and may not be dependent upon the specific condition of the patient. In other cases, chronic condition specific education may be provided to patients with specific chronic conditions. As an example, a clinical reference system may be utilized to provide educational materials to be mailed to patients. In some cases the mailings may be provided in an automated fashion (e.g., the plan manager 50 may identify materials for printing and mailing or for inclusion in mailings), but the mailings could also be handled manually. Although the mailings and other information may be, to at least some degree, specific to the chronic condition of the patient that is being managed, some mailings may be of a general nature (e.g., influenza or other vaccination reminders).

In an exemplary embodiment, the plan manager 50 may provide information to patients regarding a nurse or other care provider advice line which may be used by patients who call in to speak with a health care professional about medical symptoms and/or questions about diseases or conditions. In some cases, structured incentives may be put in place to promote use of the service by patients as well as use of the medical home assigned to each patient. Patient contact with the advice line may be recorded and, in cases where an appointment is generated via an advice line call, the appointment or follow-up care or calls may be recorded and/or scheduled in connection with the plan manager 50.

In some embodiments, the eligible patients after screening and exclusions are applied may be divided into stratified levels of care management plans. The care management plans may operate as readmission prevention programs. As such, in-patient visits, emergency department visits and total uncompensated cost of a patient may be used as criteria for patient stratification and program assignment.

At a highest level of stratification may be a readmission prevention program that may be referred to as Care Transitions Intervention (CTI) designed to utilize one or more of the feature described above that may be coordinated by the plan manager 50 and/or care management personnel in order to identify patients with a threshold level of admissions within a predetermined period of time (e.g., greater than two admissions in a one year period), but less than the threshold number of visits and/or cost to reach the next threshold in order to target such patients for readmission prevention. The readmission prevention program may provide information, follow-up services and/or reminders for ensuring patients attend routine appointments or take appropriate medications, and/or answering questions regarding recovery, wound care or healing, rehabilitation and other issues. The readmission prevention program may operate for a relatively shorter time period than higher level programs (e.g., 30 days after discharge or treatment event) and may include an individualized care plan (e.g., that may be generated by the plan manager 50) with care plan goals. Completion of the program due to expiration of the time period may trigger discharge of a patient from the plan. Readmission to the program or elevation to a higher level program may be manually triggered based on various factors or assessments. The CTI program may, in some cases, involve a higher frequency of contact with patients during admission to the program. Thus, for example, patients in the CTI program may receive calls or other personal contact at a greater frequency than patients in other programs would likely receive.

For patients with a higher incidence of patient treatment events and greater cost, another higher level of intervention may be provided in a different program. In one embodiment, the program may be referred to as a non-condition/at risk program. The non-condition/at risk program may have higher thresholds with respect to cost and incidence of in-patient and/or emergency department visits. The non-condition/at risk program may provide more aggressive management of barriers to care by the plan manager 50 and a higher level of contact and educational resources being offered and/or provided to assigned patients. Completion of the program due to expiration of a predefined time period or achievement of treatment goals may trigger discharge of a patient from the plan or transition of the patient to a higher level care plan. Readmission to the program or elevation to a higher level program may be manually triggered based on various factors or assessments as indicated above.

In some cases, one or more additional programs may be defined with even higher thresholds with respect to cost and incidence of in-patient and/or emergency department visits that serve as a stratification basis for admission to such program or programs. In one embodiment a Targeted Care Coordination product (TCare) may be employed for the highest level of a proactive care management plan. As an example, the Targeted Care Coordination product may include protocol for scheduling of follow-up care in the community and ensuring compliance, ensuring appropriate medications are prescribed and taken by patients, educating patients on self-management and monitoring self-management, and developing a structured action plan with patients to address acute deterioration of health. The product may also address barriers to care, common care elements, basic resource needs and utilization with an individualized care plan generated based on an assessment and including goal identification and progress tracking. Completion of the program due to expiration of a predefined time period or achievement of treatment goals may trigger discharge of a patient from the plan or transition of the patient to a lower or higher level care plan. Readmission to the program or elevation to a higher level program may be manually triggered based on various factors or assessments as indicated above.

In an exemplary embodiment, each level of care management plan may have different criteria for assignment thereto and also different levels of proactive engagement associated therewith. For example, although each level may include an initial assessment, the frequency of follow-up calls or visits from a home health nurse or other provider may increase in proportion to the increase in the level of care management plan. In this regard, for example, the plan manager 50 may instruct a program administrator to ensure that higher level patients (e.g., Targeted Care Coordination patients) have monthly contact with a service provider and/or greater frequency of mailings, whereas lower level patients (e.g., non-condition/at risk patients) have bimonthly contact with a service provider and/or lower frequency of mailings. Furthermore, patient access to educational and other resources (in terms of frequency and specific product access) may be plan dependent. In some instances, different conditions may also be criteria for placement in corresponding different programs. For example, certain more severe illnesses or conditions may require a higher level of care management plan be assigned (e.g., congestive heart failure, coronary artery disease, cardiac arrhythmia, deep venous thrombosis, stroke, peripheral vascular disease, chronic obstructive pulmonary disease, pulmonary embolism, diabetes mellitus, hip fracture and spinal stenosis may be specific disease diagnoses that may dictate assignment of a patient to the highest level of care management program). As such, the classifier 40 and the plan manager 50 may be configured with criteria to make patient placements into corresponding programs based on patient treatment event data and other factors.

In an exemplary embodiment, acceptance into a particular program may initiate plan manager 50 involvement in managing proactive engagement with the accepted patient for a predetermined period of time. In some cases, the predetermined period may be a fixed period such as one year. However, in other cases, the predetermined period of time may be variable based on the program into which the patient is assigned (e.g., higher level programs may have higher time periods), or may be variable based on the specific condition for which the patient is being treated. During the predetermined period of time, the plan manager 50 and/or program personnel may supplement medical home services and provide status reports to health care service providers.

Reports issued by the plan manager 50 or requested by program personnel may fall into categories such as operational, clinical, utilization and financial reports. Sources of data for producing reports may include client systems with data on prescriptions, emergency department visits, claims, and other sources. Report generation may occur at frequencies that vary by report or by program. In some cases, an annual report summarizing all of the categories above may be issued with more frequent reports on specific aspects within the categories above. For example, program participation reports may include participation statistics. Reports may also summarize call frequency and/or outcomes.

Reports may be used by clients in order to perform analysis of the impact of the programs employed with respect to various populations (e.g., the total uncompensated population, those with chronic conditions and others). For example, total cost of care, cost per patient, trends, demographics, patient segmentation, identification of impactable populations, identification of chronic patients, identification of frequent users, geographic distributions, stratification of patients exceeding high-cost benchmarks, readmission counts/rates, encounter analysis, condition prevalence and respective cost and utilization distributions, percentage of patients with a medical home and other deliverables may be provided by analysis that may be done by the plan manager 50 and delivered in reports. Reports may also indicate summaries of mailings and/or calls provided in aggregate, by program or by patient, summaries of medical home referrals made, and summaries of successful and/or failed contacts.

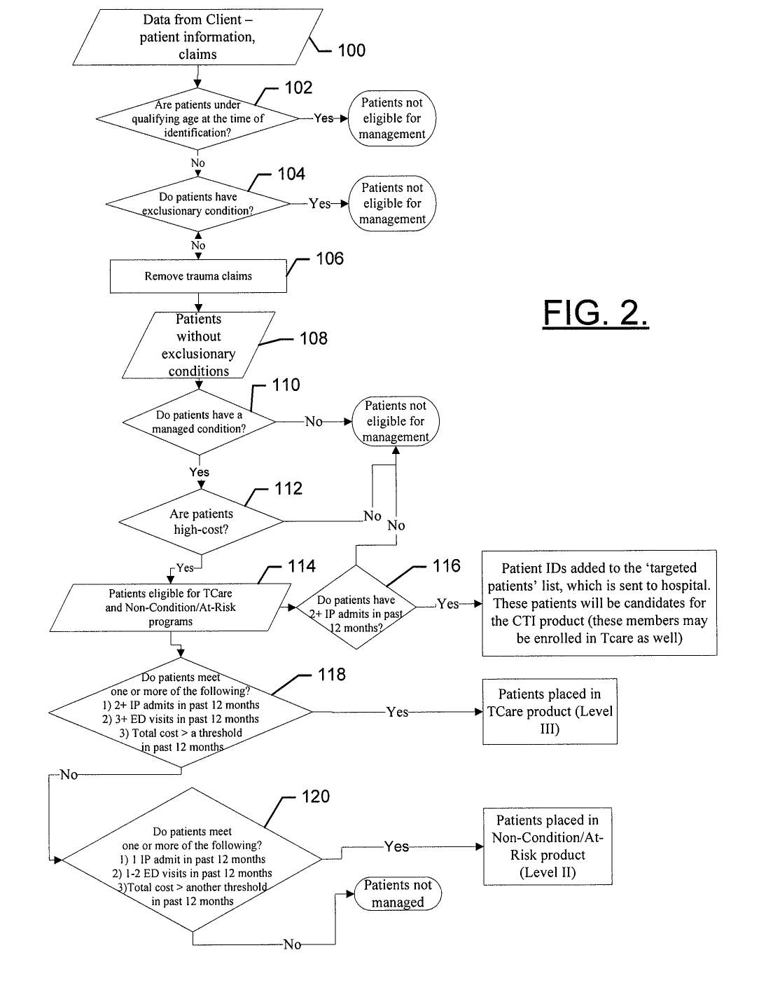

FIG. 2 illustrates a flow diagram showing several exemplary operations associated with providing management of uncompensated (e.g., uninsured or underinsured individuals) populations according to one exemplary embodiment of the present invention. As such, FIG. 2 shows some specific criteria that may be employed for exclusions and/or placement criteria according to this example. However, the specific values or other criteria shown herein should not be seen as limiting in any way.

As shown in FIG. 2, an initial data intake operation may be conducted at operation 100. During the intake process, a health care system (e.g., a client) may provide patient information and/or uncompensated claim data. Thereafter, exclusions (both medical and age related) may be applied at operations 102 to 106. In this regard, at operation 102, patients under the qualifying age may be excluded from eligibility. At operation 104, patients with excluded conditions may be removed from eligibility. In some cases, diagnostic codes (e.g., ICD 9 or ICD 10 codes) associated with claims information may be used to determined conditions and be used as a basis for inclusion/exclusion. In particular, diagnostic codes for non-chronic conditions may be excluded in some cases.

Operation 106 may ensure that trauma claims are removed. A listing of patients without exclusionary conditions 108 may then be screened for patients with managed conditions at operation 108. Patients without managed conditions are ineligible for management, while patients identified as having managed conditions are passed on to a cost screening stage. A determination may be made at operation 110 as to whether patients have a managed condition. As such, only high cost patients (e.g., greater than $1,000 in uncompensated claims in a one year period) may be retained as candidates in order to come up with a final listing of eligible patients 114 upon which a stratification and product assignment phase is performed, while patients that are not considered high cost are not eligible for management. At operation 116, all eligible patients are identified for intervention care management (e.g., CTI). Patients meeting a highest criteria for cost and frequency are placed in the highest level of care at operation 118 (e.g., TCare product described above (Level III)) and patients in between are placed in the non-condition/at risk category at operation 120 (e.g., non-condition/at risk product described above (Level II)). If any patient does not meet conditions described above, the patient is not managed.

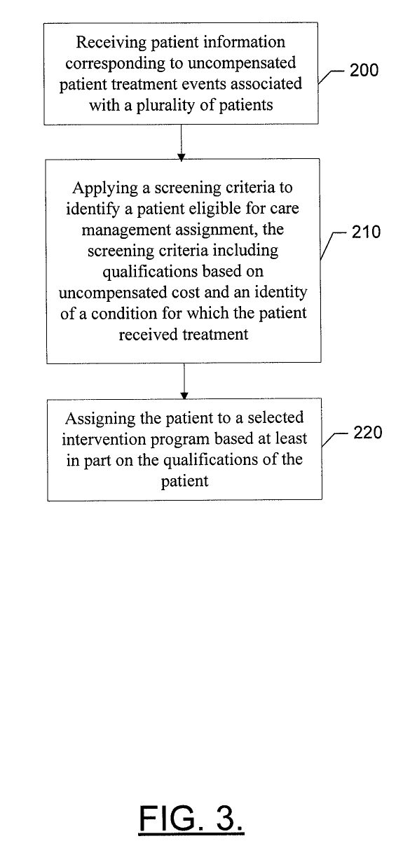

Embodiments of the present invention may be practiced using an apparatus such as the one depicted in FIG. 1. However, other embodiments may be practiced in connection with a computer program product for performing embodiments of the present invention. FIG. 3 is a flowchart of a method and program product according to exemplary embodiments of the invention. Each block or step of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 12) and executed by processing circuitry (e.g., processor 14).

As will be appreciated, any such stored computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

In this regard, a method according to one embodiment of the invention, as shown in FIG. 3, may include receiving patient information corresponding to uncompensated patient treatment events associated with a plurality of patients at operation 200 and applying screening criteria to identify a patient eligible for care management assignment at operation 210. The screening criteria may include qualifications based on uncompensated cost and an identity of a condition for which the patient received treatment. The method may further include assigning the patient to a selected intervention program based at least in part on the qualifications of the patient.

In some embodiments, certain ones of the operations above may be modified or further amplified as described below. It should be appreciated that each of the modifications or amplifications below may be included with the operations above either alone or in combination with any others among the features described herein. In this regard, for example, receiving the patient information may include receiving uncompensated claims data associated with a health care system. In some cases, applying the screening criteria may include applying exclusions to eliminate patients having exclusionary characteristics including uncompensated cost below a particular threshold, the condition not being a chronic condition or the patient having a disqualifying age. In some embodiments, assigning the patient to the selected intervention program may include utilizing frequency of treatment events to assign the patient to a corresponding level of intervention program.

In some embodiments, the method may further include other optional operations such as, for example, initiating contact with the patient based on a level of intervention program to which the patient is assigned. In some cases, the method may further include providing periodic reports regarding analysis of factors associated with a level of intervention program to which the patient is assigned or providing care management services associated with a level of intervention program to which the patient is assigned for a predetermined period of time after assignment of the patient to the intervention program. The care management services may include a calling line for providing live assistance to patients, a web or phone based video or audio resource library, mailings, appointments, compliance checks, assignment of a medical home or other services.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising processing circuitry configured to at least perform the following:
receiving patient information corresponding to uncompensated patient treatment events associated with a plurality of patients;
applying a screening criteria to identify a patient eligible for care management assignment, the screening criteria including qualifications based on uncompensated cost and an identity of a condition for which the patient received treatment; and
assigning the patient to a selected intervention program based at least in part on the qualifications of the patient.

2. The apparatus of claim 1, wherein the processing circuitry being configured to receive the patient information comprises receiving uncompensated claims data associated with a health care system.

3. The apparatus of claim 1, wherein the processing circuitry being configured to apply the screening criteria comprises applying exclusions to eliminate patients having exclusionary characteristics including uncompensated cost below a particular threshold, the condition not being a chronic condition or the patient having a disqualifying age.

4. The apparatus of claim 1, wherein the processing circuitry being configured to assign the patient to the selected intervention program comprises utilizing frequency of treatment events to assign the patient to a corresponding level of intervention program.

5. The apparatus of claim 1, wherein the processing circuitry is further configured to initiate contact with the patient based on a level of intervention program to which the patient is assigned.

6. The apparatus of claim 1, wherein the processing circuitry is further configured to provide periodic reports regarding analysis of factors associated with a level of intervention program to which the patient is assigned.

7. The apparatus of claim 1, wherein the processing circuitry is further configured to provide care management services associated with a level of intervention program to which the patient is assigned for a predetermined period of time after assignment of the patient to the intervention program.

8. A method comprising:
receiving patient information corresponding to uncompensated patient treatment events associated with a plurality of patients;
applying, via a processor, a screening criteria to identify a patient eligible for care management assignment, the screening criteria including qualifications based on uncompensated cost and an identity of a condition for which the patient received treatment; and
assigning the patient to a selected intervention program based at least in part on the qualifications of the patient.

9. The method of claim 8, wherein receiving the patient information comprises receiving uncompensated claims data associated with a health care system.

10. The method of claim 8, wherein applying the screening criteria comprises applying exclusions to eliminate patients having exclusionary characteristics including uncompensated cost below a particular threshold, the condition not being a chronic condition or the patient having a disqualifying age.

11. The method of claim 8, wherein assigning the patient to the selected intervention program comprises utilizing frequency of treatment events to assign the patient to a corresponding level of intervention program.

12. The method of claim 8, further comprising initiating contact with the patient based on a level of intervention program to which the patient is assigned.

13. The method of claim 8, further comprising providing periodic reports regarding analysis of factors associated with a level of intervention program to which the patient is assigned.

14. The method of claim 8, further comprising providing care management services associated with a level of intervention program to which the patient is assigned for a predetermined period of time after assignment of the patient to the intervention program.

15. A computer program product comprising at least one computer-readable storage medium having computer-executable program code instructions stored therein, the computer-executable program code instruction comprising:
program code instructions for receiving patient information corresponding to uncompensated patient treatment events associated with a plurality of patients;
program code instructions for applying a screening criteria to identify a patient eligible for care management assignment, the screening criteria including qualifications based on uncompensated cost and an identity of a condition for which the patient received treatment; and
program code instructions for assigning the patient to a selected intervention program based at least in part on the qualifications of the patient.

16. The computer program product of claim 15, wherein program code instructions for receiving the patient information include instructions for receiving uncompensated claims data associated with a health care system.

17. The computer program product of claim 15, wherein program code instructions for applying the screening criteria include instructions for applying exclusions to eliminate patients having exclusionary characteristics including uncompensated cost below a particular threshold, the condition not being a chronic condition or the patient having a disqualifying age.

18. The computer program product of claim 15, wherein program code instructions for assigning the patient to the selected intervention program include instructions for utilizing frequency of treatment events to assign the patient to a corresponding level of intervention program.

19. The computer program product of claim 15, further comprising program code instructions for initiating contact with the patient based on a level of intervention program to which the patient is assigned.

20. The computer program product of claim 15, further comprising program code instructions for providing periodic reports regarding analysis of factors associated with a level of intervention program to which the patient is assigned.

21. The computer program product of claim 15, further comprising program code instructions for providing care management services associated with a level of intervention program to which the patient is assigned for a predetermined period of time after assignment of the patient to the intervention program.
